(19) United States
(12) Patent Application Publication
(10) Pub. No.: US 2006/0132132 A1
(43) Pub. Date: Jun. 22, 2006

(54) Method and system for MR scan acceleration using selective excitation and parallel transmission

(75) Inventors: Yudong Zhu, Clifton Park, NY (US); Christopher Judson Hardy, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/018,144

(22) Filed: Dec. 21, 2004

(51) Int. Cl. G01V 3/00

(52) U.S. Cl. 324/309; 324/318; 324/307

(57) ABSTRACT

A radio frequency (RF) transmit coil array assembly for use in a magnetic resonance imaging (MRI) system is provided. The RF transmit coil comprises a plurality of coils arranged around an object and coupled to a pulse generator module. The pulse generator module is configured to drive the coils to induce a selective excitation pulse during a transmission mode of the MRI system. The selective excitation pulse is designed to excite an inner volume of the object and to facilitate scan acceleration and an imaging field of view is contained within the inner volume.

### BACKGROUND

This invention relates generally to magnetic resonance imaging (MRI), and more particularly, to transmit coil arrays used in MRI.

Generally, MRI is a well-known imaging technique. A conventional MRI device establishes a homogenous magnetic field, for example, along an axis of a person's body that is to undergo MRI. The homogeneous magnetic field conditions the interior of the person's body for imaging by aligning the nuclear spins of nuclei (in atoms and molecules forming the body tissue) along the axis of the magnetic field. If the orientation of the nuclear spin is perturbed out of alignment with the magnetic field, the nuclei attempt to realign their nuclear spins with an axis of the magnetic field. Perturbation of the orientation of nuclear spins may be caused by application of radio frequency (RF) pulses. During the realignment process, the nuclei precess about the axis of the magnetic field and emit electromagnetic signals that may be detected by one or more coils placed on or about the person.

The frequency of the magnetic resonance (MR) signal emitted by a given precessing nucleus depends on the strength of the magnetic field at the nucleus' location. As is well known in the art, it is possible to distinguish radiation originating from different locations within the person's body by applying a field gradient to the magnetic field across the person's body. For the sake of convenience, direction of this field gradient may be referred to as the left-to-right direction. Radiation of a particular frequency may be assumed to originate at a given position within the field gradient, and hence at a given left-to-right position within the person's body. The application of such a field gradient is also referred to as frequency encoding.

However, the application of a field gradient does not allow for two-dimensional resolution, since all nuclei at a given left-to-right position experience the same field strength, and hence emit radiation of the same frequency. Accordingly, the application of a frequency-encoding gradient, by itself, does not make it possible to discern radiation originating from the top versus radiation originating from the bottom of the person at a given left-to-right position. Resolution has been found to be possible in this second direction by application of gradients of varied strength in a perpendicular direction to thereby perturb the nuclei in varied amounts. The application of such additional gradients is also referred to as phase encoding.

Frequency-encoded data sensed by the coils during a phase encoding step is stored as a line of data in a data matrix known as the k-space matrix. Multiple phase encoding steps are performed in order to fill the multiple lines of the k-space matrix. An image may be generated from this matrix by performing a Fourier transformation of the matrix to convert this frequency information to spatial information representing the distribution of nuclear spins or density of nuclei of the image material.

Many parallel imaging techniques such as SENSE (SENSitivity Encoding) apply pulse sequences that execute a rectilinear trajectory in k space. Such techniques reduce the number of phase encoding steps in order to reduce imaging time, and then use array sensitivity information to make up for the loss of spatial information. One problem with such a technique is if the reduction factor for the phase encoding steps exceeds the number of coils arrayed in the phase-encoding direction, an incomplete removal of aliasing and poor signal to noise ratio (SNR) is realized in the SENSE reconstruction.

What is needed is a method and system to enable accelerated imaging with improved removal of aliasing and improved signal to noise ratio.

### BRIEF DESCRIPTION

Briefly, in one embodiment of the invention, a magnetic resonance imaging (MRI) system is provided. The MRI system comprises an RF transmit coil array assembly comprising a plurality of coils arranged around an object and coupled to a pulse generator module. The pulse generator module is configured to drive the coils to induce a selective excitation pulse during a transmission mode of the MRI system. The selective excitation pulse is designed to excite an inner volume of the object wherein an imaging field of view is contained within the inner volume and wherein the selective excitation pulse facilitates scan acceleration.

In another embodiment, a method for magnetic resonance imaging (MRI) with a multiple transmit coils is provided. The method comprises exciting an inner volume of the object using a selective excitation pulse and facilitating scan acceleration. The inner volume contains an imaging field of view. The method further comprises acquiring nuclear magnetic resonance (NMR) signals representative of the inner volume and processing the NMR signals to reconstruct an image.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a simplified block diagram of a Magnetic Resonance Imaging system to which embodiments of the present invention are useful;

FIG. 2 is diagrammatic view illustrating one manner in which a selective excitation pulse is applied to an inner volume;

FIG. 3 is diagrammatic view illustrating an alternative approach by which a selective excitation pulse is applied to an inner volume; and

FIG. 4 is a flow chart illustrating one method by which a field of view is imaged using a magnetic resonance imaging system.

### DETAILED DESCRIPTION

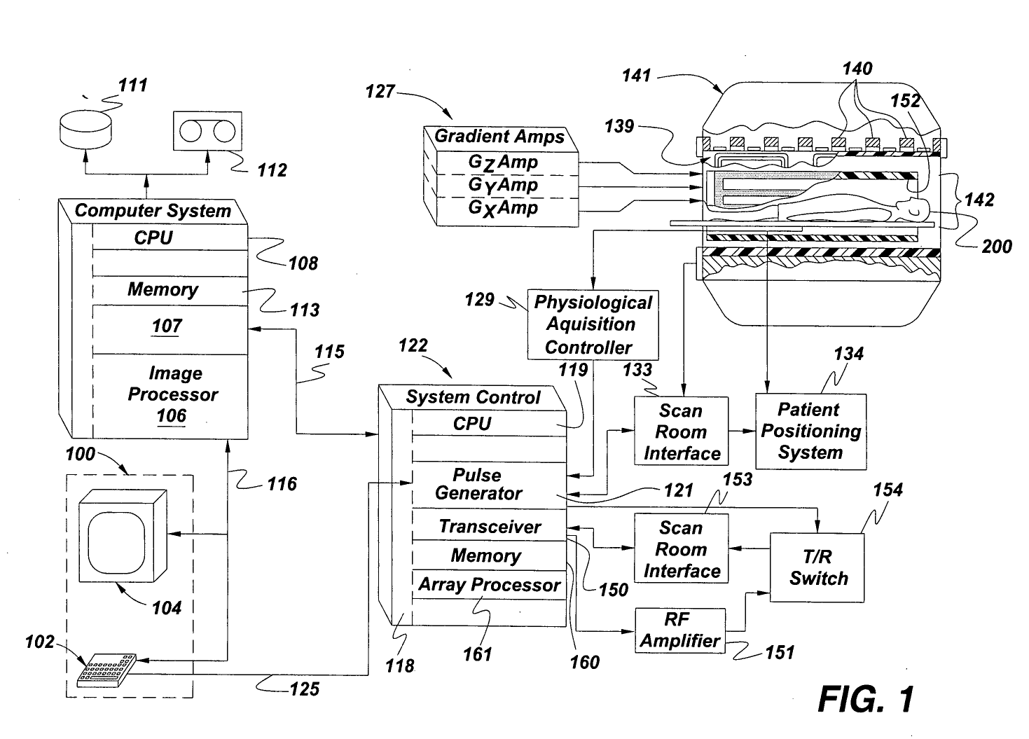

FIG. 1 illustrates a simplified block diagram of a system for producing images in accordance with embodiments of the present invention. In an embodiment, the system is an MR imaging system that incorporates embodiments of the present invention. The MR system is adapted to perform the method of the present invention, although other systems could be used as well.

The operation of the MR system is controlled from an operator console 100 which includes a keyboard and control panel 102 and a display 104. The console 100 communicates through a link 116 with a separate computer system 107 that enables an operator to control the production and display of images on the screen 104.

The computer system 107 includes a number of modules which communicate with each other through a backplane. These include an image processor module 106, a CPU module 108, and a memory module 113, known in the art as a frame buffer for storing image data arrays. The computer system 107 is linked to a disk storage 111 and a tape drive 112 for storage of image data and programs, and it communicates with a separate system control 122 through a high speed serial link 115.

The system control 122 includes a set of modules connected together by a backplane. These include a CPU module 119 and a pulse generator module 121 connected to the operator console 100 through a serial link 125. It is through this link 125 that the system control 122 receives commands from the operator that indicate the scan sequence that is to be performed. In one embodiment, the pulse generator module comprises a plurality of pulse generators.

The pulse generator module 121 operates the system components to carry out the desired scan sequence. It produces data that indicate the timing, strength, and shape of the radio frequency (RF) pulses that are to be produced, and the timing of and length of the data acquisition window. The pulse generator module 121 connects to a set of gradient amplifiers 127, to indicate the timing and shape of the gradient pulses to be produced during the scan.

The pulse generator module 121 also receives object data from a physiological acquisition controller 129 that receives signals from a number of different sensors connected to the object 200, such as ECG signals from electrodes or respiratory signals from a bellows. And finally, the pulse generator module 121 connects to a scan room interface circuit 133 that receives signals from various sensors associated with the condition of the object 200 and the magnet system. It is also through the scan room interface circuit 133 that a positioning device 134 receives commands to move the object 200 to the desired position for the scan.

The gradient waveforms produced by the pulse generator module 121 are applied to a gradient amplifier system 127 comprised of Gx, Gy and Gz amplifiers. Each gradient amplifier excites a corresponding gradient coil in an assembly generally designated 139 to produce the magnetic field gradients used for position encoding acquired signals. The gradient coil assembly 139 forms part of a magnet assembly 141 that includes a polarizing magnet 140 and a RF transmit coil array assembly 152. The RF coil array assembly 152 may include a plurality of transmit coils (not shown).

Volume 142 is shown as the area within magnet assembly 141 for receiving object 200 and includes a patient bore. As used herein, the usable volume of a MRI scanner is defined generally as the volume within volume 142 that is a contiguous area inside the patient bore where homogeneity of main, gradient and RF fields are within known, acceptable ranges for imaging.

A transceiver module 150 in the system control 122 produces pulses that are amplified by a RF amplifier system 151 and coupled to the RF coil system 152 by a transmit/receive switch system 154. The resulting signals radiated by the excited nuclei in the object 200 may be sensed by the same RF coil system 152 and coupled through the transmit/receive switch system 154 to a preamplifier system 153.

The amplified MR signals are demodulated, filtered, and digitized in the receiver section of the transceiver 150. The transmit/receive switch 154 is controlled by a signal from the pulse generator module 121 to electrically connect the RF amplifier system 151 to the coil system 152 during the transmit mode (i.e., during excitation) and to connect the preamplifier system 153 during the receive mode. The transmit/receive switch system 154 also enables a separate RF coil (not shown, for example, a head coil or surface coil) to be used in either the transmit or receive mode.

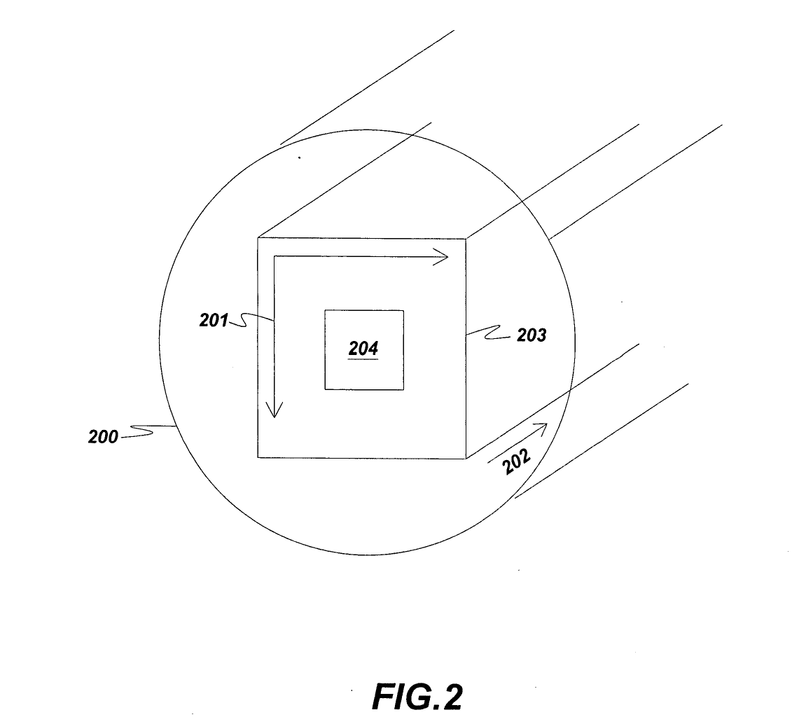

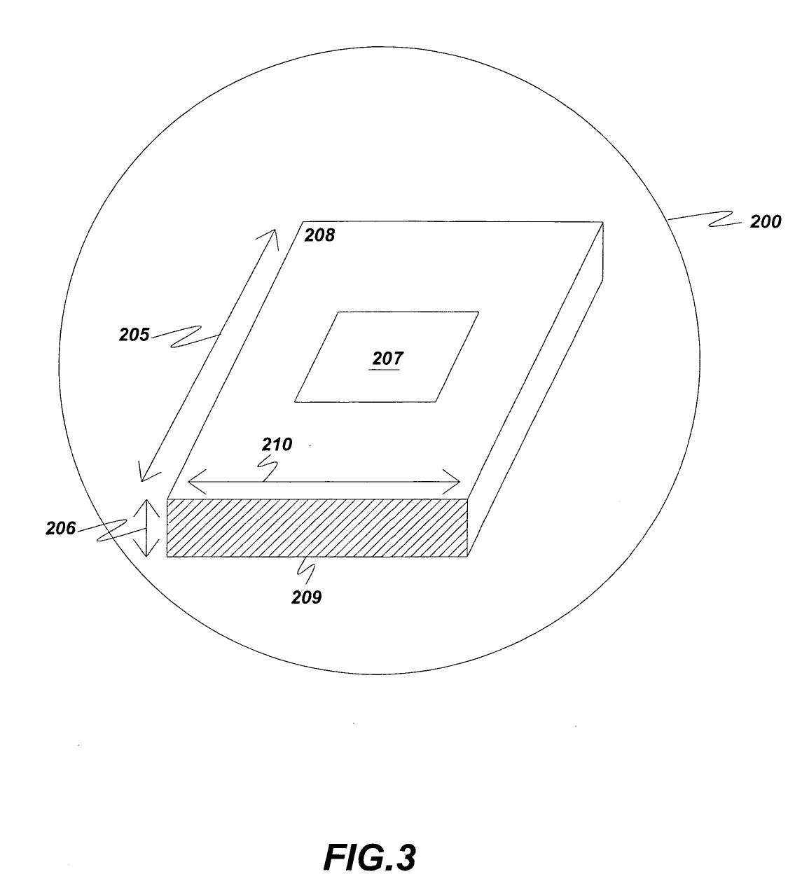

In embodiments of the present invention, radio frequency (RF) coil array assembly 152 comprises a plurality of coils arranged around the object and is configured for inducing a selective excitation pulse during a transmission mode of the MRI system. The RF coil array is further configured to reduce aliasing by using the selective excitation pulse. The manner in which the selective excitation pulse is used to acquire images is described in more detail with reference to FIG. 2 and FIG. 3.

Continuing with FIG. 1, during the transmission mode, the RF pulse waveforms produced by the pulse generator module 121 are applied to a RF amplifier system 151 comprised of multiple amplifiers. In a further embodiment, each RF amplifier is configured to simultaneously receive differently shaped RF pulse waveforms from pulse generator module 121. Each amplifier controls the current in a corresponding component coil of the coil system 152 in accordance with the amplifier's input RF pulse waveform. With the transmit/receive switch system 154, the RF coil system 152 is configured to perform transmission only, or alternatively, configured to additionally act as a receive coil array during receive mode. In another embodiment, a separate receive coil array is employed to receive MR signals.

As used herein, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that is programmed to perform a sequel to provide an output in response to given input signals.

The MR signals picked up by the RF coil system 152 or a separate receive coil (not shown, for example, a body, head or surface coil) are digitized by the transceiver module 150 and transferred to a memory module 160 in the system control 122. When the scan is completed and an entire array of data has been acquired in the memory module 160, an array processor 161 operates to Fourier transform the data into an array of image data. These image data are conveyed through the serial link 115 to the computer system 107 where they are stored in the disk memory 111.

In response to commands received from the operator console 100, these image data may be archived on the tape drive 112, or they may be further processed by the image processor 106 and conveyed to the operator console 100 and presented on the display 104. Further processing is performed by the image processor 106 that includes reconstructing acquired MR image data. It is to be appreciated that a MRI scanner is designed to accomplish field homogeneity with given scanner requirements of openness, speed and cost.

As described above, the images are acquired using a selective acquisition pulse. The selective excitation pulse is designed to excite an inner volume of the object as shown in FIG. 2. In an embodiment, the inner volume contains an imaging field of view. In a further embodiment, the selective excitation pulse is further designed to facilitate scan acceleration. The selective excitation pulse may be a two-dimensional selective excitation pulse or a three-dimensional selective excitation pulse. The selective excitation pulse is described in more detail with reference to FIG. 2 and FIG. 3.

Continuing with FIG. 1, the processor is configured to reconstruct the image using various imaging techniques. In one embodiment, a three-dimensional imaging technique. In a further embodiment, the three-dimensional imaging technique comprises applying a two-dimensional phase encoding in a plane of the image and a one-dimensional frequency encoding in a depth direction of the image.

FIG. 2 illustrates an object being imaged by a parallel imaging array, with coils aligned around an object. A three-dimensional imaging technique is used by applying two-dimensional phase encoding in the plane of the figure represented by reference numeral 201, and frequency encoding in the depth direction represented by 202.

A two-dimensional selective excitation pulse is applied to excite an inner volume 203. The inner volume 203 contains imaging field of view 204. The portions of the object outside the inner volume are not excited and thus do not contribute to aliasing in the field of view of the image. As the aliasing is substantially reduced, the unwrapped image is easier to reconstruct.

FIG. 3 illustrates an alternate embodiment where a two-dimensional imaging technique is used. In a more specific embodiment, the two-dimensional imaging technique comprises applying a one-dimensional frequency encoding along one axis of the image plane shown by reference numeral 205 and a one-dimensional phase encoding along an orthogonal axis of the image plane as shown by reference numeral 210.

The two-dimensional selective excitation is designed to define a slice 209 in one dimension as denoted by reference number 206, and to limit the signal contributing volume along the phase encoding direction as denoted by reference number 210. The imaging field of view is represented by reference numeral 207. The 2D selective excitation pulse is applied to inner volume 208 of object 200. The selective excitation pulse is used to limit the amount of aliased signal wrapping in from the object.

The techniques described in the invention allow acceleration factors in an applicable dimension that exceed the number of coils arrayed in the same dimension thus producing highly accelerated imaging. In a more specific embodiment, transmit SENSitivity Encoding (transmit-SENSE) techniques are used to shorten the selective excitation pulse length thus allowing higher bandwidth, cleaner excitation, and shorter imaging times.

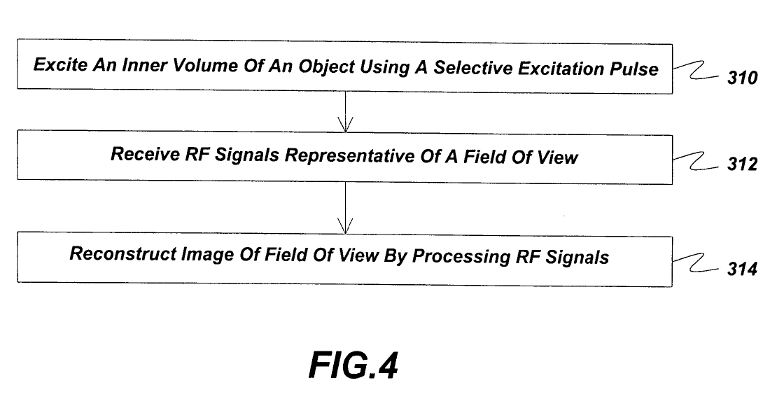

FIG. 4 is a flow chart illustrating a method to acquire images using a selective excitation pulse. In step 310, an inner volume of the object is excited using a selective excitation pulse. The inner volume contains an imaging field of view and the selective excitation pulse facilitates scan acceleration.

The selective excitation pulse is transmitted using multiple transmit coils configured for parallel excitation. Since the selective excitation pulse is applied to only excite an inner volume of the object and the inner volume is smaller than the object along one or more dimensions, aliasing is substantially reduced during parallel imaging. The selective excitation pulse may be a two-dimensional selective excitation pulse or a three-dimensional selective excitation pulse.

In step 312, nuclear magnetic resonance (NMR) signals representative of the inner volume are received by a plurality of receive coils. In one embodiment, the multiple transmit coils are used to receive the NMR signals. In an alternate embodiment, a plurality of receive coils are used to receive the NMR signals.

In step 314, an image of the inner volume is reconstructed by processing the NMR signals. The image can be reconstructed using three-dimensional imaging technique or two dimensional image techniques as is described in greater detail with reference to FIG. 2 and FIG. 3.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A magnetic resonance imaging (MRI) system comprising:
radio frequency (RF) transmit coil array assembly comprising a plurality of transmit coils arranged around an object and coupled to a pulse generator module, the pulse generator module being configured to drive the coils to induce a selective excitation pulse during a transmission mode of the MRI system;
wherein the selective excitation pulse is designed to excite an inner volume of the object and to facilitate scan acceleration and wherein an imaging field of view is contained within the inner volume.

2. The MRI system of claim 1, wherein the plurality of transmit coils is further configured to reduce a duration of the selective excitation pulse.

3. The MRI system of claim 1, wherein the RF transmit coil array assembly is further configured for acquiring nuclear magnetic resonance (NMR) signals; wherein the NMR signals comprise information representative of the object.

4. The MRI system of claim 1, further comprising a receiver coil array comprising a plurality of receiver coils configured for acquiring nuclear magnetic resonance (NMR) signals; wherein the NMR signals comprise information representative of the object.

5. The MRI system of claim 1, further comprising a processor configured for processing the acquired NMR signals and reconstructing an image of the object.

6. The MRI system of claim 5, wherein the processor is further configured for producing the image using a three-dimensional imaging technique.

7. The MRI system of claim 6, wherein the three-dimensional imaging technique comprises applying a two-dimensional phase encoding in a plane of the image and a one-dimensional frequency encoding in a depth direction of the image.

8. The MRI system of claim 5, wherein the processor is further configured for producing the image using a two-dimensional imaging technique.

9. The MRI system of claim 8, wherein the two-dimensional imaging technique comprises applying frequency encoding along one axis of the imaging plane and one-dimensional phase encoding along an orthogonal axis of the imaging plane.

10. The MRI system of claim 9, wherein scan acceleration comprises using parallel imaging.

11. The MRI system of claim 1, wherein the RF transmit coil array assembly is further configured to reduce aliasing.

12. The MRI system of claim 1, wherein the selective excitation pulse comprises a two-dimensional selective excitation pulse.

13. The MRI system of claim 1, wherein the selective excitation pulse comprises a three-dimensional selective excitation pulse.

14. A method for magnetic resonance imaging (MRI) with multiple transmit coils, the method comprising:
exciting an inner volume and facilitating scan acceleration of the object using a selective excitation pulse, the imaging field of view being contained within the inner volume;
acquiring nuclear magnetic resonance (NMR) signals representative of the inner volume; and
processing the acquired NMR signals to reconstruct an image.

15. The method of claim 14, wherein the selective excitation pulse is induced using multiple transmit coils configured for parallel excitation;

16. The method of claim 14, wherein the acquiring comprises using the multiple transmit coils.

17. The method of claim 14, wherein the acquiring comprises using the a radio frequency (RF) receive coil array.

18. The method of claim 14, wherein the acquiring and the processing comprises using three-dimensional imaging technique.

19. The method of claim 18, wherein the three-dimensional imaging technique comprises applying a two-dimensional phase encoding in a plane of the image and a one-dimensional frequency encoding in a depth direction of the image.

20. The method of claim 14, wherein the processing comprises using two-dimensional imaging technique.

21. The method of claim 20, wherein the two-dimensional imaging technique comprises applying frequency encoding along one axis of the imaging plane and one-dimensional phase encoding along an orthogonal axis of the imaging plane.

22. The method of claim 14, wherein scan acceleration comprises using parallel imaging.

23. The method of claim 14, further comprising reducing aliasing by applying the selective excitation pulse to excite the inner volume of the object.

24. The method of claim 14, wherein the selective excitation pulse comprises a two-dimensional selective excitation pulse.

25. The method of claim 14, wherein the selective excitation pulse comprises a three-dimensional selective excitation pulse
